(19) United States
(12) Patent Application Publication
(10) Pub. No.: US 2026/0156520 A1
(43) Pub. Date: Jun. 4, 2026

(54) METHODS AND DEVICES FOR APPLICATION TRAFFIC FLOWS

(71) Applicant: Telefonaktiebolaget LM Ericsson (publ), Stockholm (SE)

(72) Inventors: Lusheng JI, Los Angeles, CA (US); Alec EMMONS, Los Angeles, CA (US); Jonathan LYNAM, San Jose, CA (US)

(73) Assignee: Telefonaktiebolaget LM Ericsson (publ), Stockholm (SE)

(21) Appl. No.: 19/102,979

(22) PCT Filed: Dec. 2, 2022
(86) PCT No.: PCT/IB2022/061733

§ 371 Date: Feb. 11, 2025

Related U.S. Application Data
(60) Provisional application No. 63/371,461, filed on Aug. 15, 2022.

(51) Int. Cl. H04W 28/02

(52) U.S. Cl. CPC H04W 28/0268

(57) ABSTRACT

Methods and devices for providing improved Quality of Service (QOS) treatment for selected applications or data flows of a mobile device or other user equipment (UE). A virtual private network (VPN) service is started, and data traffic for the application is processed using the VPN service to identify packet information for the data traffic. The packet information is reported, such as to a backend service. The backend can establish one or more corresponding filters to dynamically provide the improved QoS treatment. One or more filters may also be installed on the mobile device or UE based on the packet information.

### TECHNICAL FIELD

Disclosed are embodiments related to the identification and reporting for traffic flows of mobile applications, and in particular, mapping data traffic for improved Quality of Service (QOS) treatment.

### INTRODUCTION

Technologies such as dynamic content hosting and hyperscale cloud platforms have vastly improved today's software in service availability, robustness, and scalability. Many of such advances are achieved by engineering more dynamic service deployment, invocation, and connection. For example, through dynamic service discovery and service redirect, while a client may request service through a well know hostname or IP address, the actual service can be provided by any server that the system selects when the request is received. Even for audio/video real-time communication applications, dynamic protocols, such as the Interactive Connection Establishment (ICE), can discover and configure the most suitable service endpoints with which to establish media streams.

The Quality of Service (QOS) support of today's 3GPP cellular networks is packet filter based, for instance, as set forth in 3GPP Technical Specification (TS) 23.401 (“General Packet Radio Service (GPRS) enhancements for Evolved Universal Terrestrial Radio Access Network (E-UTRAN) access”) and TS 24.501 (“Non-Access-Stratum (NAS) protocol for 5G System (5GS)”). First radio and core service bearers are set up in a cellular network such that each of them is configured with specific transport priorities and scheduling weights targeting different desired QoS effects, for the purpose of serving different QoS needs. Where IP packets are injected into a cellular network, packet filters can be installed to separate out and dispatch IP packets onto different bearers so that the packets receive their corresponding QoS treatments.

An example of this setup is illustrated in FIG. 1. In this example, end-to-end bearers across an LTE cellular network are shown, and the packet filters are installed as part of the Traffic Filter Templates (TFTs) at the user equipment (UE) and gateway (P-GW) ends.

These packet filters work by matching values of certain fields in an IP packet against a set of preconfigured values or value ranges while processing the packet. Existing filters are “static” configurations-the filtering criteria and values are predetermined. Such packet filters compare the values of five fields in an IP packet's header, namely the source IP address, destination IP address, transport layer protocol, transport layer source port, and transport layer destination port. Often, these 5 values are collectively referred to as the 5-tuples.

There remains a need for improved traffic flow controls, monitoring, and/or filtering, for instance, that is able to address dynamic services in a network or QoS support.

### SUMMARY

According to embodiments, a method in a user equipment (UE) is provided that comprises starting a virtual private network (VPN) service; processing data traffic for an application, where the processing comprises using the VPN service to identify packet information for the data traffic; and reporting the packet information. The packet information may be reported, for example, to a backend service for establishing improved performance for the UE. In certain aspects, the method is for dynamically providing improved Quality of Service (QOS) treatment for the application. As such, the method may further include, for example, receiving a user request for improved QoS treatment. One or more filters may also be installed on the UE based on the packet information.

According to embodiments, a method in a node is provided that comprises: receiving packet information from a UE, where the packet information is for data traffic of an application for which improved QoS treatment is requested; and establishing one or more corresponding filters to provide the improved QoS treatment. In some embodiments, establishing the filters may comprise requesting that a provider network (e.g., a provider for the UE) install one or more filters. In some embodiments, the method may further comprise performing one or more optimizations for the filters.

According to embodiments, an apparatus, such as a UE or node, is provided that is configured to perform one or more of the methods. For example, an apparatus may comprise a receiver/transmitter and a processor, wherein the processor is configured to perform one or more of the methods. In some embodiments, the node may be a backend service for establishing boosted service for a UE, such as a cloud-implemented backend.

According to embodiments, a computer program is provided that comprises instructions that when executed by processing circuitry of an apparatus causes the apparatus to perform one or more of the methods.

### BRIEF DESCRIPTION OF THE DRAWINGS

The accompanying drawings, which are incorporated herein and form part of the specification, illustrate various embodiments.

FIG. 1 illustrates an example of end-to-end bearers of a cellular network.

FIG. 2 illustrates a system according to embodiments.

FIG. 3 illustrates a system according to embodiments.

FIG. 4 is a diagram showing data traffic in a system according to some embodiments.

FIGS. 5A and 5B are flow charts illustrating data mapping process flows according to some embodiments.

FIG. 6 is a flow chart illustrating a process according to embodiments.

FIG. 7 is a flow chart illustrating a process according to embodiments.

FIG. 8 illustrates a system according to embodiments.

FIG. 9 illustrates a user device according to embodiments.

FIG. 10 illustrates a network node according to embodiments.

FIG. 11 is a block diagram of a host according to embodiments.

FIG. 12 is a block diagram illustrating a virtualization environment according to embodiments.

FIG. 13 shows a communication diagram of a host communicating in a network according to embodiments.

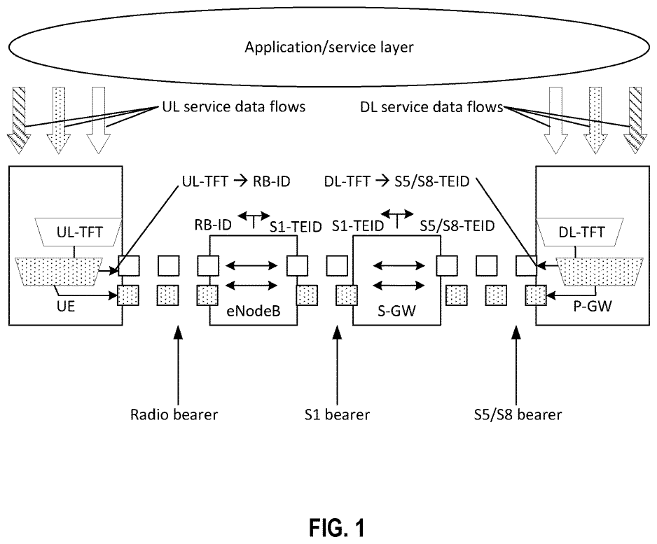

### DETAILED DESCRIPTION

Certain challenges exist. For example, dynamic service deployment, invocation, and connection technologies have presented a challenge for how cellular networks'Quality of Service (QOS) support can be applied to mobile applications (or “apps”). In these dynamic scenarios, exact service endpoints that provide the actual service, or other data flow information, can become unpredictable.

In order to filter out packets belonging to a specific app data traffic flow for applying adequate QoS handling, the mobile network usually needs to be told the 5-tuple values to filter on packets of the flow. This is because the mobile network is typically not involved in any of the app's service connection decisions. Even if the mobile network knows the 5-tuples for all the data flows it is carrying data for, the mobile network in general does not know which flow is for which app, or which function of which app. For this reason, traditionally these filters rely on static configurations where the filtering criteria and values are predetermined based on app provider shared traffic parameters, such as firewall configuration parameters, or study of app behavior. A greater use of dynamically discovered and negotiated server endpoints will result in increased challenges in providing effective static configurations.

One way to mitigate these issues could be to widen the value range for certain filtering fields of a filter to cover more possible values, or even use wildcards. However, this approach would also allow packets not intended for QoS treatment to be put on QoS elevated bearers because they would pass the widened filters. For example, when a service is deployed on a cloud platform, it may potentially be assigned any IP address that the provider chooses from its IP address pool. To cover all possibilities, the IP address filter would likely have to cover all IP addresses possessed by the cloud provider. Unfortunately, data traffic for other services running on the same cloud platform will also use these addresses, and packets for those services will also pass the IP address filter for this QoS demanding service. In some cases, transport layer port values can be used jointly with IP address to focus a filter, but it may be ineffective if the port behavior of the intended app is also dynamic, or it uses common ports such as 80 or 443.

Further, ill-intentioned parties may set up proxies in the same cloud so that all proxied traffic would pass such a widened filter and receive elevated QoS treatment. In other words, wide filters may not be capable of sufficiently differentiating traffic (e.g., from other apps and allow other apps'traffic entering the same bearer that is set up for the boosted app traffic only). This can result in degradation of QoS for the desired app because the unintended traffic would congest communication channels. This could also lead to revenue loss due to usage of radio and network resources by unintended traffic. Such unplanned uses of communication resources can also make network dimensioning difficult.

One application of embodiments is with respect to backend boosting technology. An example of this is the Dynamic End-user Boosting (DEB) technology developed by the Ericsson Business Area Technologies and New Businesses (BTEB) One Network Solutions (ONS) organization, which empowers end-users with the ability to request on-demand elevated QoS treatment, or a QoS “boost”, in real-time for apps running on their mobile phones. Using the boost app, an end-user interested in a boost can make a request to an ONS-developed cloud service, known as the DEB backend, to start boost for a specific app's traffic. The backend, after verifying business logics, will request the end-user's Cellular Service Provider (CSP) to configure its network and the end-user's mobile phone to provide elevated QoS treatment for this app's data traffic. Embodiments may be applied in other contexts as well.

As a pre-condition for supporting boost, the CSP should have already set up bearers of different QoS grades in its network for transporting packets of different app QoS needs. The separation of the boosted app's data packets for special QoS treatment in “Ludicrous” boosting, for example, is currently based on static filter configuration. For this reason, for each app to be included in the Ludicrous QoS boost offering, a process known as the “app characterization” is completed to identify the remote server IP addresses and ports used by the app, for the purpose of deriving the filtering criteria and filtering parameter values. Unfortunately, in many cases the range of server IP addresses and ports discovered through the app characterization process may not yield usable results. For instance, it may not provide filter parameters that are narrow enough to be acceptable by the CSP customers.

Moreover, app service providers often change their server IP pools over time. For example, to answer increased demands, or expansion to new geological regions, a service provider often times signs up cloud platform service with new providers to expand service capacity, service availability, and platform diversity, which results in the use of new IP addresses not seen during the app characterization process. With an approach that is in the control plane after the characterization is done, the new server IP addresses will not be discovered and data traffic with the new cloud provider would experience no QoS boost because the current filters do not cover the new IP addresses. App characterization would thus need to be redone to correct the filters. But not being able to tell whether it is seeing new server IP addresses leaves the boost service provider (or other similar service) in the dark for when re-characterization of an app is needed.

Thus, a limited, static filter configuration may be undesirable for dynamic services. Aspects of this disclosure provided the capability of dynamically configuring cellular network packet filters in real time based on actual service connections. Embodiments may provide, for example, such solutions in the context of mobile phone apps.

In certain aspects, embodiments disclose methods and devices that can address one or more of the foregoing challenges, and provide dynamic services to a wide array of applications. In certain aspects, this may be regardless of how dynamic their service endpoints are, or how fragmented the service provider's IP address pool is. Embodiments may also help prevent unintended packets from obtaining improved QoS treatments, mitigate confusion or over/under inclusion from changing IP addresses, deter illicit use of proxies to bypass filters and their negative effects on revenue, ease dimensioning decisions, reduce network congestion, and/or avoid degradation of QoS, thereby improving end-user satisfaction and service quality.

According to some embodiments, to accommodate various kinds of dynamics in server endpoint changes, the data plane is used, for example, either by having the boosted end-user app notify the backend of the 5-tuples used by its data flows or gaining visibility into the data flows used by the app so that the 5-tuples can be observed, and the backend notified. Solutions described herein can be flexible. For instance, while the former may be ideal for apps whose developers are willing to incorporate the use of the backend's notification API, it may not necessarily be applicable to apps that do not call the backend notification API. Aspects of the disclosure may relate primarily to the second scenario, and may not require additional development effort from the app developers, thus enabling any app to request and benefit from a QoS boost. Four examples of benefits are described below.

First, a mobile app service or “mapper” running on the end user's mobile phone or other UE can be deployed in the data plane, where it can process traffic flows for the app to be boosted and have visibility into all traffic flows of the app. Thus, it can determine the precise 5-tuples that the flows are using. The mobile network can then be configured to filter on the exact IP addresses and ports. Moreover, no matter how dynamic the to-be-boosted app's service discovery and connection process are, as soon as a new connection to services is established and data packets start to flow into/from the selected service endpoint, the 5-tuples of these packets are immediately visible to the mapper. Accordingly, and in some embodiments, the mapper can install or update the packet filters to reflect the 5-tuples of the newly established connections. This can avoid the “wide filter” problems discussed above because other apps or traffic flows will not have the exact same 5-tuples.

Second, the mapper can observe the packets and perform passive measurement. There are multiple benefits to this capability. The volume and throughput moving averages that are observed can be used immediately by the mapper to identify which flows to boost. They can also be stored in the backend for app behavior analysis studies and various data-backed intelligence gathering. Such information can be valuable for app statistics, security, and network traffic engineering applications. The differences between performance results such as app data throughout, latency, jitter, etc. measured by the mapper with boosting vs. without boosting (e.g., with packet filters installed vs. without), can also illustrate the performance gain that is achieved by boosting. According to embodiments, such measurement and collection are conducted with user permission.

Third, for one or more of apps whose service discovery and connection behaviors are not especially dynamic, the mapper and its backend can also determine that—after initiation—the traditional static configuration approach would work reasonably well. For this set of apps, the boost could still employ static filter configuration to enjoy the lightweight aspects of the mechanism. In some embodiments, once an app is determined to be “static configuration friendly,” processes disclosed herein may only need to be rerun from time to time to verify whether the app remains static configuration friendly, and update its filter parameters if necessary. This can draw on benefits of certain approaches. In characterization-based static filter approaches, run-time processing of app traffic is not necessarily required. After an app is characterized and packet filter configuration is stored, the processing remains in the control plane. When requested, the backend may only need to retrieve the filter configurations for the boost-requesting app from its database and requests the CSP to install corresponding packet filters. In certain aspects, with this approach, the boost request can be made by anybody with the correct authorization, such as an administrator, without involving the mobile phone.

Fourth, when the data traffic handled by the mapper service is of the local breakout Virtual Private Network (VPN) type, embodiments may not require VPN gateways. Although traditional VPN services can be applied to support boosting according to embodiments, using local breakout can have additional advantages. Not only does it avoid the expensive operation of running VPN gateway infrastructure, but the local breakout traffic typically also goes directly from mobile phone to server, avoiding the extra delay of triangle routing (i.e., data that goes from mobile phone to gateway then from gateway to server) and the encryption/decryption operation performed by the gateway. As such, embodiments can provide improved performance at the UE in some applications.

According to embodiments, a service runs on a device that requests an improved QoS, for instance, for an application running on a UE. In certain aspects, the service may run in the background and have a companion user interface module and/or controller. A backend, for instance a cloud-based backend service for providing boosted performance for the device, can receive data traffic flow information from a service running on the device (e.g., mobile phone), and generate filter configurations based on the information. For instance, it can request filters to provide improved QoS treatment for the application data flow. Additional intelligence such as QOS requirement information may also be derived, including for making recommendations for network bearer configuration optimization. According to embodiments, the backend interacts with the network, such as a 3GPP cellular network, that exposes service Application Programming Interfaces (APIs) through one or more components, such as Service Capability Exposure Function (SCEF) and Network Exposure Function (NEF). The exposed API can allow the backend to request QoS configuration and device subscription. A CSP-provided custom API for the same purpose may also be utilized.

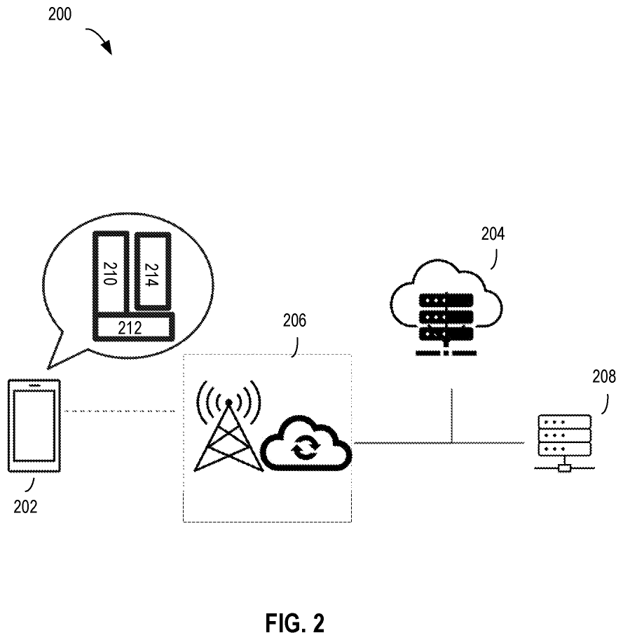

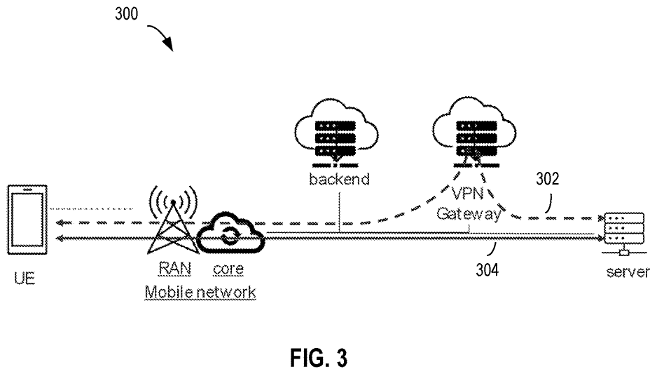

FIG. 2 and FIG. 3 illustrate systems according to some embodiments.

Referring now to FIG. 2, in a system 200, a user equipment (UE) 202, such as a mobile phone, may be served by one or more parties. While a mobile phone is used as an example, other UEs may be used. In the example of FIG. 2, the system 200 comprises the mobile phone 202, the mobile network 206 serving the mobile phone, a backend 204 supporting the operations, and one or more servers 208 providing app services to mobile phone 202. The network 206 may comprise, for example, Radio Access Network (RAN) and/or core components. According to embodiments, the UE comprises one or more software components or modules that are involved in boost operations, such as requesting/obtaining improved QoS treatment. This may include, for instance, an end-user app (or background app) 214 whose traffic flows have been requested to receive a boost, the mobile service (or “mapper”) 212 using a VPN connection, and a controller app 210 (e.g., a mapper controller), which provides a user interface or other functionality for controlling the service. In certain aspects, the mapper may use traditional VPN services and/or local breakout VPN services, as described in connection with FIG. 3.

According to embodiments, the mapper service 212 employs a VPN service, such that the mapper processes data packets for applicable apps 214, and thus, can gather information on the app's flow parameters such as the 5-tuples. Other information may be gathered according to embodiments. The mapper can then identify the type of data carried by certain flows and decide how to forward each of these flows, some sent out directly from the mobile phone while others forwarded to a VPN gateway just like a true VPN service, according to embodiments. In certain aspects, the mapper reports the traffic parameters such as the 5-tuples of the flows requested to receive special QoS treatment to the backend 204. The backend can, in turn, request that the end-user's CSP provide special treatment for packets fitting the traffic parameters, for example, by transporting them on corresponding bearers set up for the type of data that the flow carries.

In some embodiments, accurate app traffic boosting may require precise traffic parameter knowledge. This may include, for instance, 5-tuple information. However mobile platforms, such as IOS and Android, carefully protect active network data flow information.

From apps, direct access to flow information maintained inside of the platform kernel is generally disallowed, other than limited access via permitted APIs provided by platform software developer kits (SDKs), which do not include discovering what traffic flows other apps use.

Cross-app visibility for what flows a different app is using is also not allowed. These limitations make getting the 5-tuple information for the network data flows of a third-party app from outside of the app itself difficult, which can be addressed by embodiments.

For example, the mapper 212 can overcome the visibility problem by functioning as a VPN service. VPN service is very useful in mobile scenarios, and its platform mechanics are already supported by mobile platforms including both IOS and Android. Being implemented as a special VPN service in embodiments, the mapper gets to process data packets for other apps, and thus, gains visibility into their traffic parameters such as the 5-tuples of these packets. Additionally, modern mobile platforms also offer “per-app” features for mobile VPN services. That is, when a VPN service is invoked, it can be configured so that only data traffic for a selected set of apps would go through this VPN service. This can be leveraged by the devices and methods described with respect to embodiments herein. When combining the mapper 212 with the “per-app VPN” feature, it can be configured for only processing data traffic for the selected apps. In other words, when an end-user requests a boost for an app, and the mapper's VPN service is started as the “per-app VPN” for this particular app, the mapper will only process data traffic for this boosted app according to some embodiments. After the mapper VPN service is started as the per-app VPN for the to-be-boosted app, the mobile platform will route all outgoing data packets from this app to the mapper service. According to embodiments, a user or administrator can specify an app, and the mobile phone kernel is configured so that only packets for the specified app are passed to the VPN service. For instance, embodiments may comprise identifying one or more data flows of the application for improved QoS treatment (e.g., identifying flows that would benefit the most from a service boost), where the VPN service identifies one or more data flows of the application by using a mobile phone platform's per-app-VPN configuration created for only handling data for the application. According to embodiments, reverse direction traffic can also go through the mapper VPN service. Thus, as the mapper 212 processes these packets, it can gather the traffic parameters such as the 5-tuples for this to-be-boosted app, and reports to the backend these learned parameters (e.g., periodically or in real time).

FIG. 3 illustrates how, according to embodiments, the UE 202 (e.g., with mapper 212) may choose to forward app packets in both a traditional VPN technique and the local breakout technique in a system 300. The system 300 may use, for instance, the network and devices described in connection with system 200. As shown in FIG. 3, a first path 302 is used by packets sent using a traditional VPN. The second path 304 is used by packets sent with local breakout VPN techniques.

By way of background, traditional VPN service for a packet is completed at two ends. The ingress end node encrypts a received data packet and sends the encrypted packet to the egress end. The encrypted packet is usually sent encapsulated. That is, as payload of packets addressed to the egress end, a technique often known as tunneling. The egress end decapsulates the packet, decrypts the encrypted packet to restore its original form, and sends it out onto the Internet towards its destination. In addition, Network Address Translation (NAT) is applied so that the outgoing packet, which is the decrypted original packet, would have the egress node as its source. In mobile VPN scenarios, for uplink traffic, the ingress node is performed by the VPN service app running on the mobile phone and the egress node is usually a server on the Internet, often referred to as a VPN gateway. The response packet to the first packet would travel in the reverse direction, from the server to the mobile VPN gateway (now functioning as the ingress node for the response packet), encrypted and sent to the mobile phone's VPN service software which performs decryption then forwarded to the app that originated the first packet. According to embodiments, working with mobile VPN gateways, the UE (e.g., with mapper 212) can forward a boosted app's data in this or other traditional VPN ways. In these cases, it is possible for the mapper to report the 5-tuple information for the VPN tunnel, and such information can be used to request boost for all traffic going through the tunnel.

In some embodiments, the invocation of VPN service and/or per-app VPN service requires the end-user's acknowledgement and permission, for instance, for security and privacy reasons. For example, the end-user can be notified that the service will process data packets for the selected app for the purpose of providing QoS boosting, and the end-user's positive acknowledgement may be required before the mapper is started.

In some embodiments, the UE (e.g., mapper 212) can send the contents of the app's packets out using sockets that the mapper owns over the cellular modem network interface of the mobile phone. This is sometimes referred to as a type of local breakout. One form of local breakout is the App Resource Optimizer (ARO) application, which was open-sourced by AT&T and can be used according to embodiments. In certain aspects of the embodiment, local breakout packets are sent directly towards their destinations (e.g., server 208) from the UE 202. Not only does this avoid the additional delay incurred by the encryption/decryption operations and the longer forwarding path going through a VPN gateway (e.g., the best QoS in certain scenarios), it also relieves the service provider from operating the VPN gateway infrastructure. However, with traditional VPN, the VPN path does provide some additional security because data is protected by the VPN on the network segment from the CSP network to VPN gateway. The decision of which flow is going on which path can be made based on several factors, such as the availability of a VPN gateway, and a customer's requirements on security. According to some embodiments, the VPN service is a local breakout service that differentiates the handling of data flows, where one or more data flows are local breakout and the remaining flows are tunneled towards a remote VPN gateway. In certain aspects, the locally broken-out data flows can be proxied by the VPN service, where contents of the data packets are extracted and sent out using sockets created and managed by the VPN service.

According to some embodiments, regardless of the manner in which the mapper forwards app packets, it knows the 5-tuples of the packets being sent out onto the cellular network. For instance, in some embodiments, they are either what the VPN tunnel is using (e.g., with a traditional VPN), or the parameters of the sockets used in local breakout forwarding.

For embodiments using local breakout traffic flows, the mapper 212 may need to identify which flows to put on elevated QoS treatment. This is because modern mobile apps usually employ many different traffic flows for different functions of the app, and not all of them are requested for (or deemed relevant for) special QoS bearers since they generally have different QoS needs. According to embodiments, boost is provided for the flows that would benefit the most. For example, the Microsoft Teams app uses HTTP(S) REST API calls to cloud servers for calendar and contact information retrieval, file sharing, etc., and Real-time Transport Protocol (RTP) flows with media servers for real-time audio and video communications in meetings. The real-time audio/video flows typically have high QoS requirements, while contact retrieval can function quite well even in poor QoS conditions. Thus, in embodiments, the mapper 212 may only report data flow information for the real-time audio and/or video communications, and not report for flows used for contact information retrieval. This is an example, and other metrics and/or identifiers may be used for selecting flows for reporting and/or boosting.

Another reason for the mapper 212 to only report a subset of flows is that, in practice, the number of packet filters that can be installed for the UE 202 is limited. This is because: (1) filtering packets does require computing resources so there is a limit; and (2) the 3GPP specifications can specify a maximum number of packet filters. Thus, for complex apps that may employ hundreds of different data traffic flows, it is not necessarily possible to have enough filters for all flows. Thus, benefits are achieved according to some embodiments. For instance, selective reporting on flows reduces the overall traffic volume being carried by QoS elevated bearers, as well as reducing complexity of the packet filters as there are fewer servers to filter for. Such selection occurs where the mapper can identify which flow is for which function. Being the packet handler for all traffic flows for an app, it is possible for mapper 212 to identify some of these most beneficial flows and report the 5-tuples for them. For example, when the mapper sees a flow consisting of uplink User Datagram Protocol (UDP) packets of equal size (small) and equal inter-packet arrival time, it may infer that this is likely a real-time audio data flow and hence report the flow's 5-tuple to the backend as audio traffic 5-tuple. Subsequently, the backend would request the CSP to install packet filter with this 5-tuple for a bearer specifically set up for carrying real-time audio data. Similarly, uplink UDP packets arriving in groups and equal inter-group arrival time may suggest these are real-time video packets and their 5-tuples can be used for filters for the CSP's video traffic bearer.

According to embodiments, the mapper may identify the top-N flows for which boost will be requested, where N is subject to system constraints, by data volume, or throughput.

According to embodiments, the mapper reports the 5-tuples of the boost candidate flows either periodically, or differentially (e.g., reporting the addition or removal of 5-tuples as they are discovered), or both approaches may be combined.

After the backend request is processed, the packet filters with the 5-tuples of the identified to-be-boosted data flows can be installed into the UE 202 and the network 206 (e.g., the CSP network). The backend 204 may introduce additional optimization in this process according to embodiments. After installation, packets passing these filters, which are the ones belonging to the data flows reported by mapper 212, are dispatched onto their corresponding bearers for QoS appropriate transportation.

Further, the UE (e.g., via mapper 212) can conduct passive measurements (e.g., measurements by observation only) on interested flows. These measurements can be valuable in verifying boost effectiveness, troubleshooting, and generating end-user permitted intelligence on user app network traffic behaviors. Direct measurable metrics include, according to some embodiments, per-flow throughput, packet size and inter-arrival statistics, flow duration and flow use patterns, etc. In certain aspects, the mapper can record the metrics while processing the app's packets. With the use of Deep Packet Inspection (DPI) techniques, for instance, when a request-response packet pair is identified, additional metrics such as round-trip latency can be calculated. These are examples, and more results can also be derived from these direct measurement results.

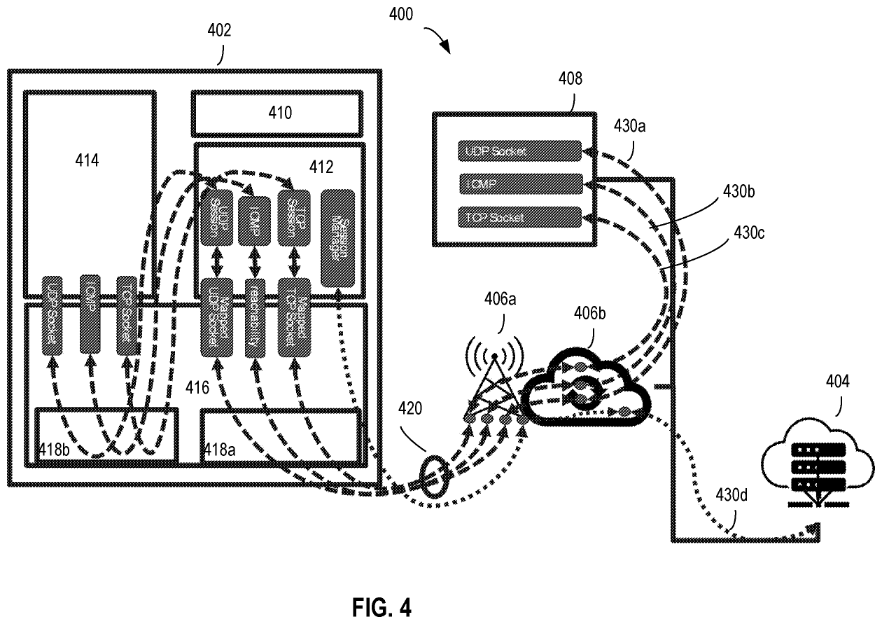

Referring now to FIG. 4, aspects of the operations of a mobile service according to embodiments, such as mapper 212 and other associated components, are illustrated. For example, the operations of FIG. 4 may be applied in the context of system 200 or 300. The flows of FIG. 4 may correspond, for instance, to local breakout packet processing. However, where applicable, more traditional VPN method may be applied. In the system 400 of FIG. 4, a UE 402 communicates with the backend 404 via a mobile network comprising one or more of a RAN 406a and/or core network 406b. System 400 also includes server 408, and the UE has an application 414, controller 410, and mapper 412. The UE 402 also comprises, in some embodiments, a mobile platform kernel 416 and one or more network interface cards (NICs), such as a Tunnel NIC 418b (virtual) and Cellular NIC 418a (physical) in some embodiments. In this example, data packets flow from the application 414 (e.g., a boosted app) through the virtual NIC tunnel to the mapper 412, and from the mapper 412 out through the cellular NIC (e.g., via one or more mapped sockets or “reachable” API). Certain traffic goes to the server 408 via the mobile network, such as boosted traffic 420. Other information, such as tuple information, flows to the backend 404. In certain aspects, the data packet information is provided from a session manager of the mapper 412. Return traffic may follow one or more of the same paths according to embodiments. In certain aspects, the UE 402 employs a “tun/tap” virtual interface.

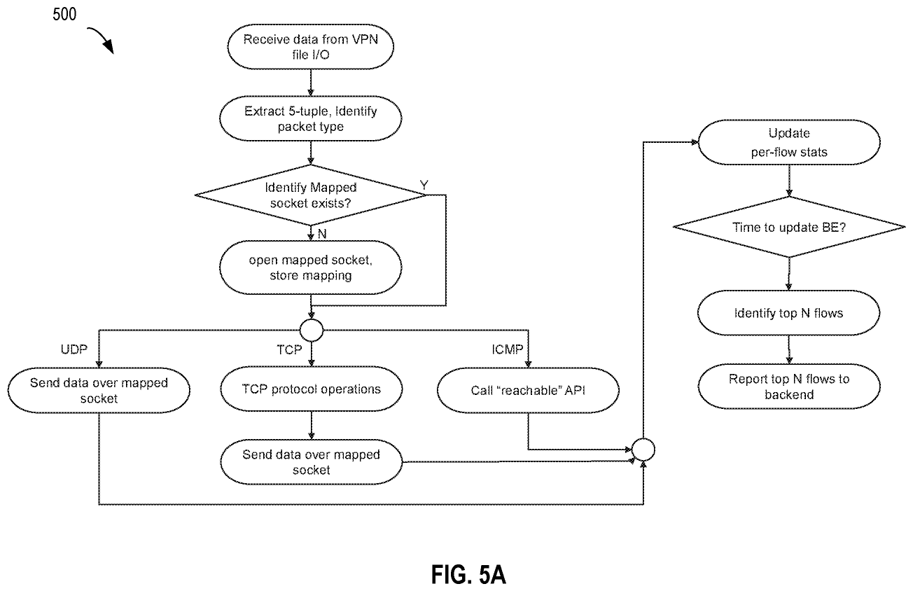

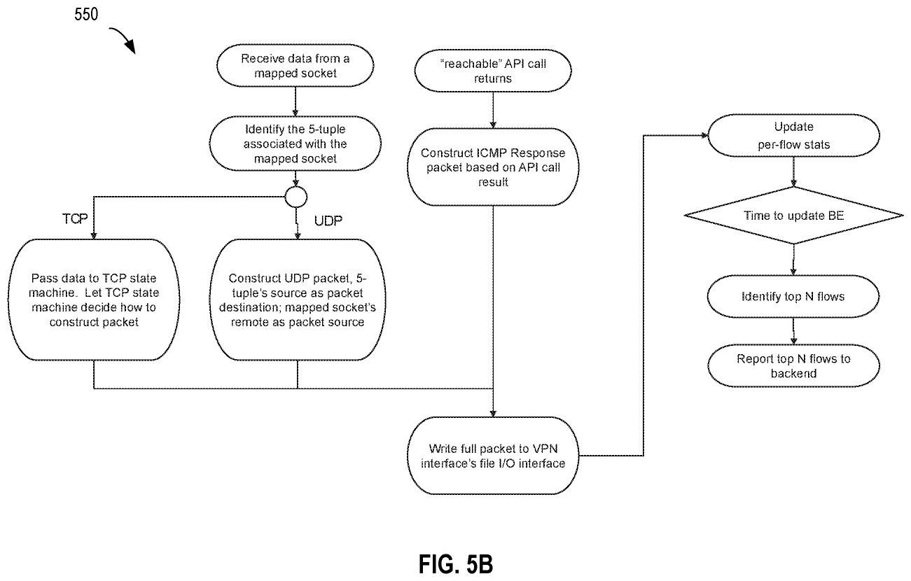

In this example, when an end user requests boosted service for a specific app 414 through the controller 410, a mapper service 412 instance is activated as a VPN service for the mobile platform 416 of UE 402. At the same time, information regarding the boosted app 414 is used for configuring the mobile platform's per-app VPN feature with the mapper 412 as the VPN service so that the requested app's data traffic will be routed to the mapper VPN interface. In embodiments, the VPN interface is realized as a virtual interface inside of the mobile platform's kernel space 416. This interface will redirect any received outgoing packets to mobile platform's user space by writing all the bytes of the packet to a file input/output (I/O) interface. The mapper 412, which is a service running in user space in certain aspects, receives these bytes by reading the file I/O interface. Then the mapper parses the received bytes as an IP packet, and identifies the packet type as being Transmission Control Protocol (TCP), User Datagram Protocol (UDP), or Internet Control Message Protocol (ICMP). The mapper further processes this packet based on its type. Additional aspects of this are shown, for example, in FIGS. 5A and 5B. When the file I/O interface read returns bytes belonging to more than one packet, they can be separated during parsing.

For a UDP packet, a mapper extracts the data part of the packet, then sends the data out using a mapped UDP socket. According to embodiments, a mapped socket can be a socket opened by the mapper when an outgoing packet with a new 5-tuple is received from the VPN interface for the first time. The mapped socket is opened towards the same destination IP address and port, and of the same type, as the triggering packet but bonded to the physical cellular network interface as its local interface, in some embodiments. The mapping between the mapped socket and the triggering packet's 5-tuple can be stored for later look-up. When receiving a UDP packet from the VPN's file I/O interface, a mapped socket is identifiable based on the packet's 5-tuple. Data contents of the UDP packet are sent out using the mapped socket, resulting in data going out over the cellular network interface towards the packet's original intended destination, for instance, as illustrated in FIG. 4.

For a UDP packet of the reverse direction (e.g., server to a mobile phone's app, or “downlink”), it will arrive on a mapped UDP socket in the example of FIG. 4. This is because the corresponding uplink packet that the server received was from a mapped socket as described above. Based on which mapped socket such a packet arrives on, the mapper identifies the original 5-tuple that was used for creating the mapped socket. According to some embodiments, the mapper then constructs an IP packet for carrying the data received on the mapped socket.

The destination IP and port of this packet are set to the source IP and port of the 5-tuple, and the source IP and port of the packet are set to the server's IP address and port. In certain aspects, where the mapper only sees the data part of the received reverse direction UDP packet, the IP address and port of the sender (server) are retrieved from the mapped socket. The constructed packet is then written into the file I/O interface for the VPN virtual NIC byte by byte. The VPN virtual NIC and the mobile platform kernel will deliver this packet to the original UDP socket of the boosted app. The UDP paths are illustrated in FIG. 4 as path 430a.

For a TCP packet, because TCP connections are stateful, in addition to forwarding the data carried in this packet onto a mapped TCP socket as shown in FIG. 4, the mapper also reacts to the packet according to the TCP protocol in some embodiments. For example, it can implement a TCP state machine that performs TCP protocol operations such as byte ordering, acknowledging received byte sequence, advancing buffer window, etc. Correspondingly, when data is received on a mapped TCP socket, such data is injected into the TCP state machine of the TCP connection towards the boosted app first according to some embodiments. The TCP state machine will construct the correct TCP packet for the connection with the boosted app including setting the proper TCP header, then write the packet onto the VPN virtual interface's file I/O interface. This path is illustrated in FIG. 4 as path 430c.

Overall, the processing of UDP and TCP packets is like that of a TCP/UDP proxy or a NAT device. However, the mapper has IP packet level access to packets on the VPN file I/O interface side but only has transport layer socket level access on the cellular network interface side. Normally a proxy or NAT device has raw IP packet access on both sides.

In some embodiments, the handling of ICMP packets is different because mobile platforms typically do not allow apps to access raw sockets for creating ICMP packets. The mapper cannot directly send ICMP packets over the cellular interface. Thus, when receiving an ICMP packet from the VPN interface's file I/O interface, instead of constructing a mapped ICMP request, the mapper extracts the destination of the ICMP request and invokes an equivalent mobile platform SDK API call, such as the “reachable” call. Once the API call is returned, the mapper would need to construct a raw ICMP response packet and writes it to the VPN interface's file I/O interface. Aspects of the path for ICMP are shown with path 430b in FIG. 4.

The descriptions above are directed to the mapper's processing of the app's packets. According to embodiments, such processing happens as long as the mapper VPN is active, and the end-user app is sending and receiving data. Whether the cellular network offers QoS elevated treatment to flows is transparent to the mapper and the above processing. Boosting is an “out-of-band” configuration change in the cellular network requested by the mapper and backend as illustrated by the path 430d in FIG. 4. This out-of-band process consists of several steps in some embodiments. For example, while processing an app's packets, the mapper identifies the flows to be boosted and reports the 5-tuple information of the mapped sockets for these flows. The backend 404 receives the 5-tuple information, performs optimization, and requests the mobile network (e.g., 406a, 406 b) to install filters based on the 5-tuple information received from mapper. After the filters are in place, the boosting becomes effective because packets for the boosted flows are now separated out and placed on their special bearers.

Referring now to FIGS. 5A and 5B, data processing flows 500, 550 are shown according to some embodiments. In FIG. 5A, process 500 is provided for when data arrives on the VPN, for instance, on the VPN virtual interface's file I/O interface. In FIG. 5B, a process 550 is provided for when data arrives on a mapped socket or a “reachable” API call returns.

Processes 500, 550 may be performed, for example by a UE as described in connection with FIGS. 2, 3, 4, and 9 according to some embodiments.

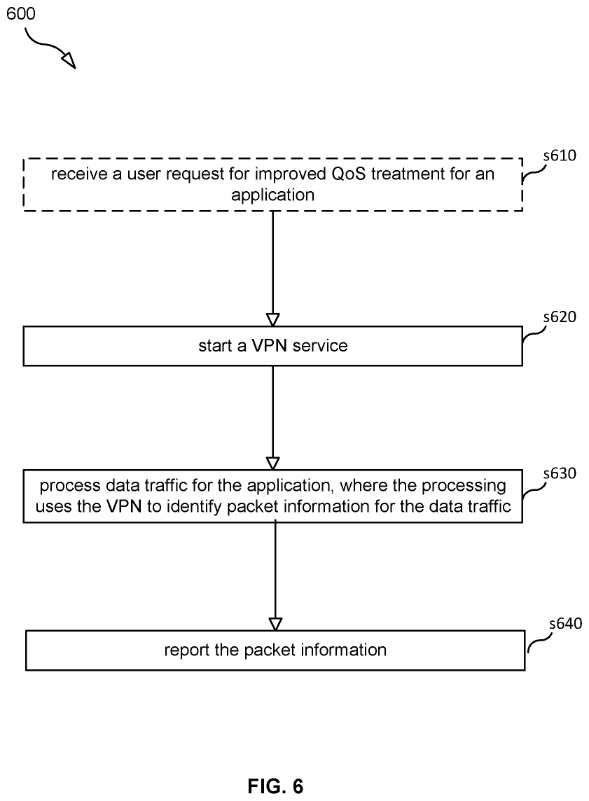

Referring now to FIG. 6, a process 600 is provided according to some embodiments. The process 600 may be performed, for instance, by a UE as described in connection with FIGS. 2, 3, 4, 8 and 9. The process 600 may begin, in some embodiments, with step s610 in which a user request for improved QoS treatment for an application is received. This step may be optional. In step s620, a VPN service is started, for instance, a VPN service for the application of step s610. The UE then, in step s630, processes data traffic for the application. According to embodiments, the processing uses the VPN to identify packet information for the data traffic.

Examples of the packet information include one or more tuples (e.g., source IP address, destination IP address, transport layer protocol, transport layer source port, and transport layer destination port). In certain aspects, step s630 may comprise identifying one or more data flows of the application for improved QoS treatment (e.g., identifying flows that would benefit the most from a service boost). In step s640, the packet information is reported. This packet information can be used for establishing one or more corresponding filters, at the UE and/or in the network. In some embodiments the packet information (e.g., 5-tuples) is reported to a backend (e.g., a cloud-implemented backend service for establishing boosted service for a UE).

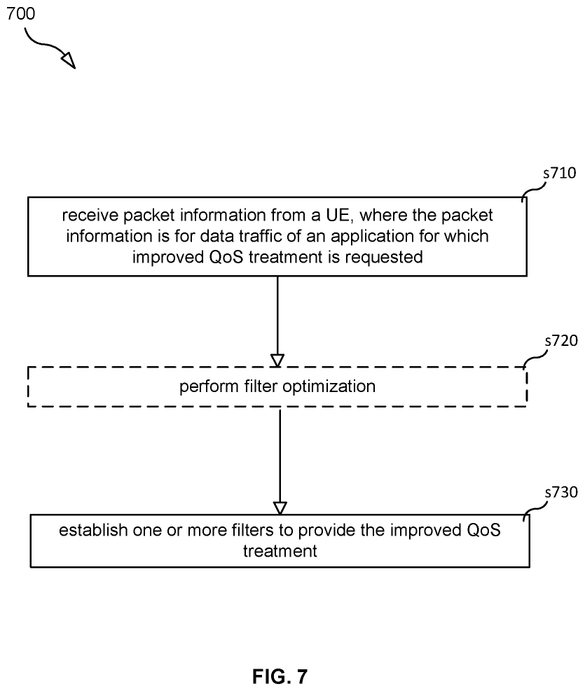

Referring now to FIG. 7, a process 700 is provided according to some embodiments. The process 700 may be performed, for instance, by a node or backend as described in connection with FIGS. 2, 3, 4, 8, and 10-13. The backend may be, for example, a cloud-implemented backend or server, such as a backend service for establishing boosted service (e.g., improved QoS treatment) for a UE. According to embodiments, the backend can also perform one or more business logic or other functions, such as authorization (e.g., requested by a registered user), billing and accounting, logging, gating (request rate limiting in many dimensions, such as total number of requests per minute, per UE, per cell tower, per locality, etc.), and others. The process may begin, according to some embodiments, with step s710. In step s710, packet information is received from a UE, where the packet information is for data traffic of an application for which improved QoS treatment is requested. In some embodiments, the packet information is obtained by the UE according to process 600. In step s720, which may be optional in some embodiments, a filter optimization is performed. The optimization may comprise, for example, analyzing the received packet information (e.g., to identify common/redundant tuples in the received packet information). Based on the analyzing, the node can then generate a reduced set of corresponding filters (e.g., by aggregating tuples to reduce the number of filters, using a wildcard in one or more filter fields, etc.). In some embodiments, optimization and/or filter generation may be based on behavior mining. For instance, the backend may consider time of day of requests, what apps are requested, etc. In step s730, one or more filters are established for providing the improved QoS treatment. This could include, for example, requesting that a provider network, such as a CSP for the UE, install one or more filters.

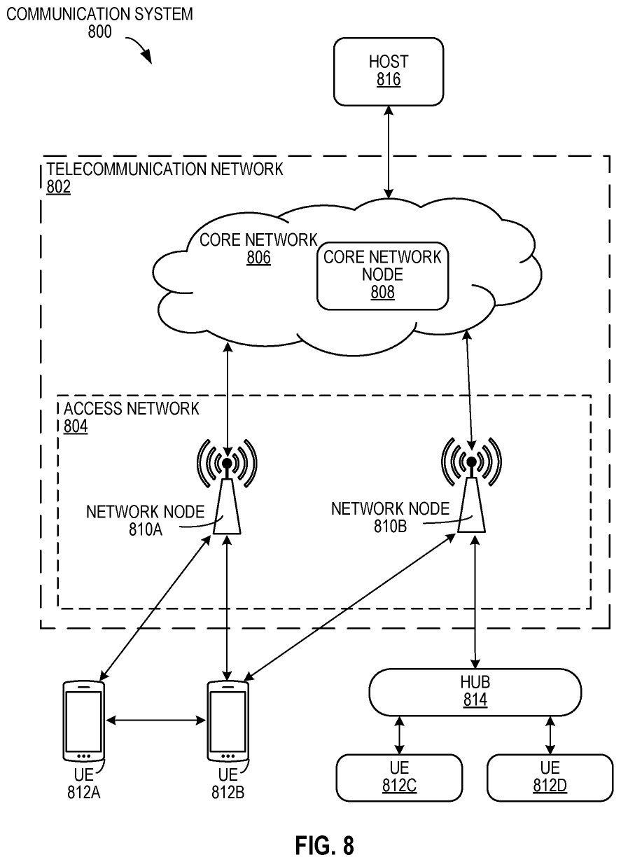

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub-that is, a hub whose primary function is to route communications to/from the UEs from/to the network node 810b. In other embodiments, the hub 814 may be a non-dedicated hub-that is, a device which is capable of operating to route communications between the UEs and network node 810b, but which is additionally capable of operating as a communication start and/or end point for certain data channels.

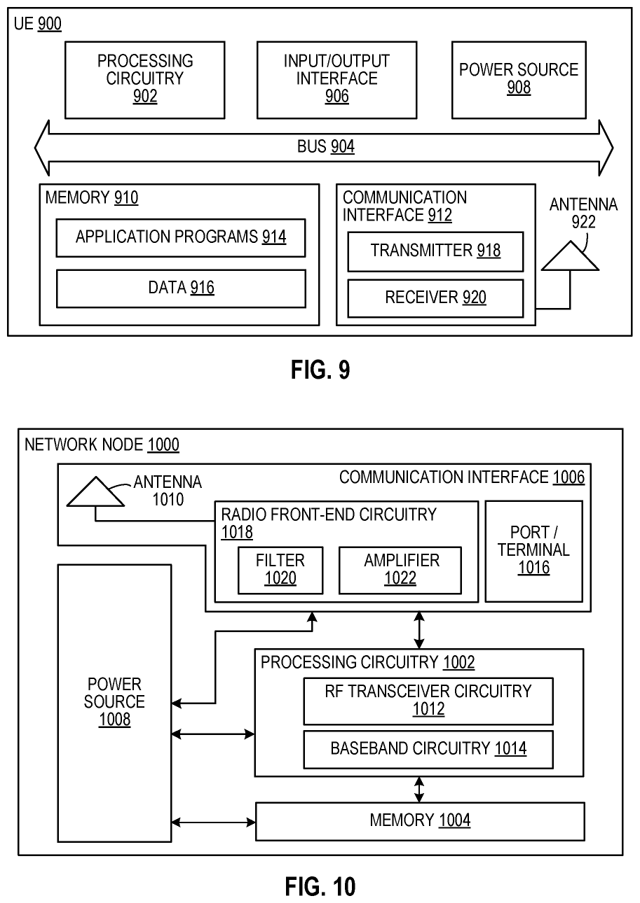

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908.

Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node.

Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Some examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment.

Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

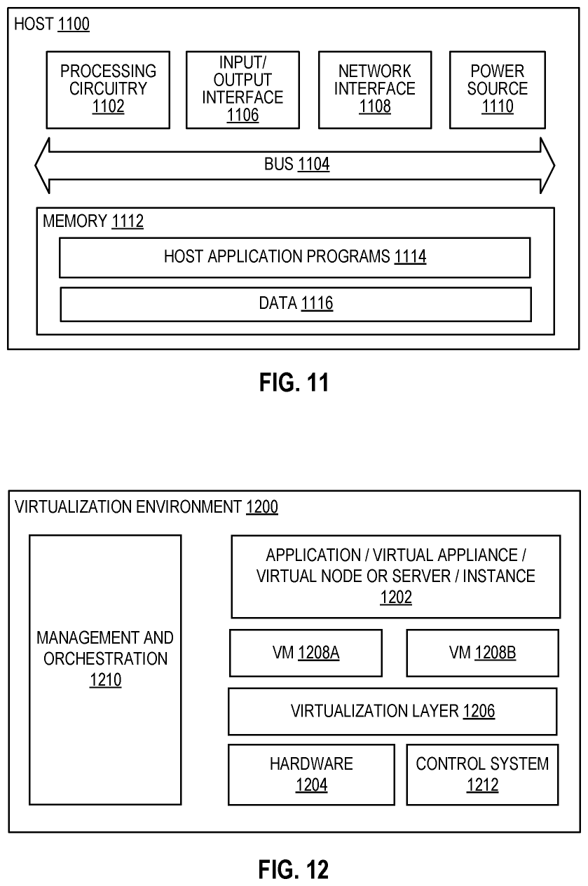

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), dynamic adaptive streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1200 includes components defined by the O-RAN Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206.

Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine.

Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization.

Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

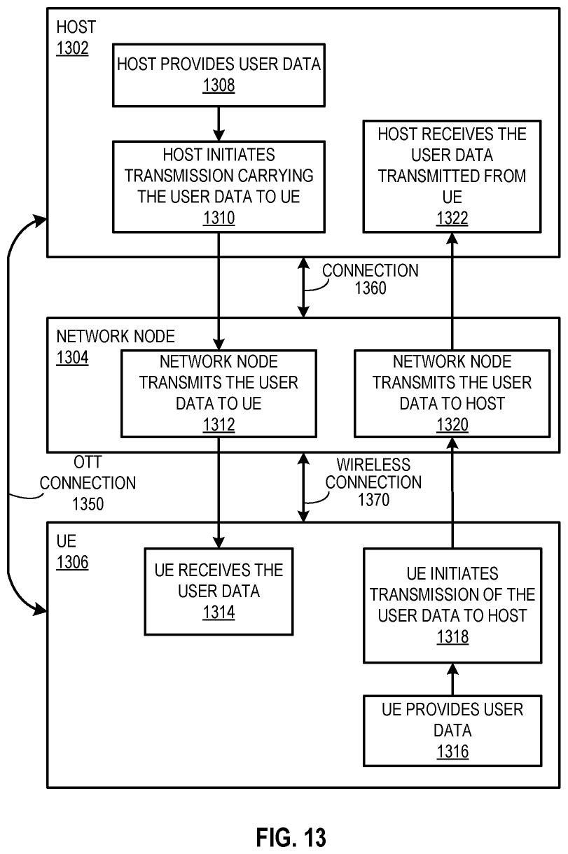

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the data rate or latency, and thereby provide benefits such as reduced user waiting times or better responsiveness.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### SUMMARY OF EMBODIMENTS

A1. A method in a user equipment, UE, comprising: starting a virtual private network, VPN, service; processing data traffic for an application, wherein the processing comprises using the VPN service to identify packet information for the data traffic; and reporting the packet information.
A2. The method of A1, wherein the identified packet information comprises one or more tuples (e.g., source IP address, destination IP address, transport layer protocol, transport layer source port, and transport layer destination port).
A3. The method of A1 or A2, further comprising: receiving a user request for improved Quality of Service, QoS, treatment for the application.
A4. The method of any of A1-A3, wherein the packet information (e.g., 5-tuples) is reported to a backend (e.g., a cloud-implemented backend service for establishing boosted service for a UE).
A5. The method of any of A1-A4, further comprising: activating a mapper service instance on the UE (e.g., wherein the VPN interface is realized as a virtual interface inside of the UE platform's kernel space).
A6. The method of any of A1-A5, further comprising: requesting user permission to process the data traffic using the VPN service.
A7. The method of any of A1-A6, further comprising: identifying one or more data flows of the application for improved QoS treatment (e.g., identifying flows that would benefit the most from a service boost).
A8. The method of any of A1-A7, wherein the reporting is for packet information relating to only a subset of data flows for the application.
A9. The method of A7 or A8, wherein the data flows comprise one or more of: (i) audio and/or video flows (e.g., Real-time Transport Protocol, RTP, flows with media servers for real-time audio and/or video); (ii) a selected number of top-N data flows (e.g., selected according to system constraints, data volume, or throughput); and/or (iii) file sharing flows.
A10. The method of any of A1-A8, wherein reporting is: (i) periodic; (ii) differential (e.g., packet information is reported to add or remove tuples as they are discovered); or (iii) both periodic and differential.
A11. The method of any of A1-A10, further comprising: installing one or more data filters based on the identified packet information (e.g., to filter data based on identified 5-tuples).
A12. The method of A11, further comprising: determining a change to a data flow of the application, or a change in the identified packet information for the application; and in response, updating at least one of the installed data filters or reporting updated packet information.
A13. The method of any of A1-A12, further comprising performing one or more measurements of the data traffic (e.g., one or more flows) of the application (e.g., to verify boost effectiveness, troubleshoot, generate data, etc.).
A14. The method of A13, wherein the one or more measurements comprise: (i) volume, (ii) throughput (e.g., per-flow throughput), (iii) packet size, (iv) inter-arrival statistics, (v) flow duration, (vi) flow use patterns, (vii) jitter, or (viii) round-trip latency.
A15. The method of A13 or A14, further comprising: storing and/or reporting at least one of the measurements.
A16. The method of any of A1-A15, further comprising: sending a request (e.g., to a backend service) for improved QoS treatment for one or more data flows of the application.
A17. The method of A16, wherein the request comprises the reporting of the packet information.
A18. The method of any of A1-A17, wherein the VPN service is a local breakout service.
A19. The method of any of A1-A18, wherein processing the data traffic for the application comprises: writing (and/or reading) bytes of the data traffic to (and/or from) a file I/O interface.
A20. The method of A19, further comprising: parsing the bytes (e.g., as one or more IP packets); and identifying a corresponding packet type (e.g., Transmission Control Protocol, TCP; User Datagram Protocol, UDP; or Internet Control Message Protocol, ICMP) for the bytes; wherein the data processing (e.g., packet information identification) is performed based at least in part on the corresponding packet type.
The method of A20, wherein the packet type is uplink UDP and the data processing comprises: extracting a data part of the packet; and sending application data using a mapped UDP socket (e.g., using a mapped socket identified based on the packet's 5-tuple).
A22. The method of A20, wherein the packet type is reverse or downlink UDP and the data processing comprises: receiving the packet on a mapped UDP socket; identifying an original 5-tuple based on the mapped socket; and constructing an IP packet for carrying application data received on the mapped socket, wherein the destination IP and port of the packet are set to the source IP and port of the 5-tuple, and the source IP and port of the packet are set to the sender server's IP address and port, and wherein the IP address and port of the sender (server) are retrieved from the mapped socket.
A23. The method of A20, wherein the packet type is TCP and the data processing comprises: implementing a TCP state machine, wherein the state machine writes the packet onto the VPN virtual interface's file I/O interface.
A24. The method of A20, wherein the packet type is ICMP and the data processing comprises: extracting the destination of the ICMP request; invoking an equivalent UE platform application programing interface, API, call; once the API call is returned, constructing a raw ICMP response packet; and writing the packet to the VPN interface's file I/O interface.
A25. The method of any of A1-A24, wherein the method is for providing improved Quality of Service, QoS, treatment for the application.
B1. A user equipment, UE, configured to: start a virtual private network, VPN, service; process data traffic for an application, wherein the processing comprises using the VPN service to identify packet information for the data traffic; and report the packet information.
B2. The UE of B1, further configured to perform any of the steps of A2-A25.
B3. The UE of B1 or B2, comprising: a mapper module (e.g., comprising the mapper VPN service); and a controller module (e.g., to provide user control interface(s)).
C1. A method in a node (e.g., a cloud-implemented backend), comprising: receiving packet information from a user equipment, UE, wherein the packet information is for data traffic of an application for which improved Quality of Service, QoS, treatment is requested; and establishing one or more corresponding filters to provide the improved QoS treatment.
C2. The method of C1, wherein establishing the filters comprises requesting that a provider network (e.g., a Cellular Service Provider, CSP, for the UE) install one or more filters.
C3. The method of C1 or C2, further comprising: performing one or more optimizations for the corresponding filters.
C4. The method of C3, further comprising: analyzing the received packet information (e.g., to identify common/redundant tuples in the received packet information); and based on the analyzing, generating a reduced set of corresponding filters (e.g., by aggregating tuples to reduce the number of filters, using a wildcard in one or more filter fields, etc.).
C5. The method of any of C1-C4, wherein the node is a cloud-implemented backend service for providing improved QoS treatment for data traffic to or from the UE.
C6. The method of any of C1-C5, wherein the received packet information comprises one or more tuples (e.g., source IP address, destination IP address, transport layer protocol, transport layer source port, and transport layer destination port).
C7. The method of any of C1-C6, wherein the received packet information is for one or more data flows of the application.
C8. The method of any of C1-C7, wherein the received packet information relates to only a subset of data flows for the application.
C9. The method of any of C1-C8, wherein the packet information is received: (i) periodically; (ii) differentially (e.g., packet information is received to add or remove tuples as they are discovered); or (iii) both periodically and differentially.
C10. The method of any of C1-C9, further comprising: determining a change to the received packet information for an application; and in response, updating at least one of the corresponding filters.
C11. The method of any of C1-C10, performing one or more measurements of data traffic (e.g., one or more flows) of the application (e.g., to verify boost effectiveness, troubleshoot, generate data, etc.).
C12. The method of C11, wherein the one or more measurements comprise: (i) volume, (ii) throughput (e.g., per-flow throughput), (iii) packet size, (iv) inter-arrival statistics, (v) flow duration, (vi) flow use patterns, (vii) jitter, or (viii) round-trip latency.
C13. The method of C11 or C12, further comprising: storing and/or reporting at least one of the measurements.
C14. The method of any of C1-C13, further comprising: receiving a request (e.g., from the UE) for improved QoS treatment for one or more data flows of the application.
C15. The method of C14, wherein the request comprises the received the packet information.
D1. A node configure to: receive packet information from a UE, wherein the packet information is for data traffic of an application for which improved Quality of Service, QoS, treatment is requested; and establish one or more corresponding filters to provide the improved QoS treatment.
D2. The node of D1, further configured to perform any of the steps of C2-C15.
E1. A computer program product comprising a non-transitory computer readable medium storing instructions which when performed by processing circuitry of a device causes the device to perform any of A1-A25 or C1-C15.
While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method in a user equipment, UE, comprising:
starting a virtual private network (VPN) service;
processing data traffic for an application, wherein the processing comprises using the VPN service to identify packet information for the data traffic; and
reporting the packet information.

2. The method of claim 1, wherein the identified packet information comprises one or more tuples.

3. The method of claim 1, wherein the identified packet information comprises source internet protocol (IP) address, destination IP address, transport layer protocol, transport layer source port, and transport layer destination port.

4. The method of claim 1, further comprising:
receiving a user request for improved Quality of Service (QOS) treatment for the application.

5. The method of claim 1, wherein the packet information is reported to a backend service for establishing improved QoS service for the UE.

6. The method of claim 1, further comprising:
requesting user permission to process the data traffic using the VPN service.

7. The method of claim 1, further comprising:
identifying one or more data flows of the application for improved QoS treatment.

8. The method of claim 7, wherein the data flows of the application are identified using an application-specific VPN configuration of the UE.

9. The method of claim 1,
wherein the reporting is for packet information relating to only a subset of data flows for the application, and
wherein the data flows comprise one or more of:
(i) audio or video flows;
(ii) a selected number of top-N data flows selected according to system constraints, data volume, or throughput; or
(iii) file sharing flows.

10. (canceled)

11. The method of claim 1, further comprising:
installing one or more data filters based on the identified packet information.

12. The method of claim 11, further comprising:
determining a change to a data flow of the application, or a change in the identified packet information for the application; and
in response, updating at least one of the installed data filters or reporting updated packet information.

13. The method of claim 1, further comprising:
performing one or more measurements of the data traffic of the application; and
performing one or more of storing or reporting the results of at least one of the measurements.

14. The method of claim 1, further comprising:
sending a request for improved QoS treatment for one or more data flows of the application.

15. The method of claim 14, wherein the request comprises the reporting of the packet information.

16. The method of claim 1, wherein the VPN service is a local breakout service.

17. The method of any of claim 1, wherein the VPN service is configured to differentiate a plurality of data flows of the UE, wherein one or more of the data flows are local breakout, and wherein the remaining data flows are tunneled towards a remote VPN gateway.

18. The method of claim 17, wherein the local breakout data flows are proxied by the VPN service, and wherein contents of the data packets for the local breakout data flows are extracted and sent using one or more sockets created and/or managed by the VPN service.

19. The method of claim 1, wherein processing the data traffic for the application comprises:
writing or reading bytes of the data traffic to or from a file input/output (I/O) interface.

20. The method of claim 19, further comprising:
parsing the bytes; and
identifying a corresponding packet type for the bytes;
wherein the processing is performed based at least in part on the corresponding packet type.

21. A user equipment, UE, configured to:
start a virtual private network, VPN, service;
process data traffic for an application, wherein the processing comprises using the VPN service to identify packet information for the data traffic; and
report the packet information.

22-39. (canceled)
